(19) United States
(12) Patent Application Publication
(10) Pub. No.: US 2026/0055627 A1
(43) Pub. Date: Feb. 26, 2026

(54) BATTERY MODULE CONTAINER WITH A PROTECTIVE STEP, ELECTRICAL POWER STORAGE SYSTEM AND ASSOCIATED METHOD

(71) Applicant: SAFT, LEVALLOIS PERRET (FR)

(72) Inventors: Quentin LIEVOUX, LE BOUSCAT (FR); Jennifer CRONIER, MERIGNAC (FR); Stephen AICOBERRY, Saint Loubes (FR); Matthieu BERTIN, VILLENAVE D’ORNON (FR); Arnaud COLLIGNAN, SAINTE EULALIE (FR); Clément THÉTIOT, CARIGNAN DE BORDEAUX (FR)

(73) Assignee: SAFT, LEVALLOIS PERRET (FR)

(21) Appl. No.: 19/100,772

(22) PCT Filed: Aug. 10, 2023
(86) PCT No.: PCT/EP2023/072156

§ 371 Date: Feb. 3, 2025

(30) Foreign Application Priority Data
Aug. 12, 2022 (FR) 22 08280

(51) Int. Cl. E04H 1/12; H01M 10/42; H01M 50/204; H01M 50/251

(52) U.S. Cl. CPC E04H 1/1205; H01M 10/425; H01M 50/204; H01M 50/251; E04H 2001/1283; H01M 2220/10

(57) ABSTRACT

This container includes a structure comprising a floor support with two longitudinal stringers and crossmembers connecting same, each longitudinal member having an upper face, a floor having an upper support surface for supporting said modules and extending up to the lateral edges facing the longitudinal members, peripheral walls, at least one of which defines a door (92A) movable between a closed position in which a lower edge is facing said upper face and an open position, and a roof above the peripheral walls.

Along the lower edge of the door in the closed position, the lateral edge of said upper surface extends to a height above that of said upper face, the floor support defining a step between said face and upper surface, delimiting a water-receiving volume.

### CROSS REFERENCE TO RELATED APPLICATIONS

The present application is a U.S. National Phase Application under 35 U.S.C. § 371 of International Patent Application No. PCT/EP2023/072156 filed Aug. 10, 2023, which claims priority of French Patent Application No. 22 08280 filed Augst 12, 2022. The entire contents of which are hereby incorporated by reference.

### FIELD OF THE INVENTION

The present invention relates to a battery modules container, including a structure comprising:
a floor support, comprising two lateral longitudinal members, lower corner pieces fixed to the ends of the longitudinal members and crossmembers connecting the longitudinal members together, each longitudinal member having an upper face,
a floor supported by the floor support, the floor having an upper surface for supporting the battery module extending to lateral edges arranged facing the longitudinal members,
peripheral walls, at least one peripheral wall defining at least one door movable between a closed position in which a lower edge of the door extends facing the flat upper face of the longitudinal member and an open position, and
a roof, arranged above the peripheral walls, the floor, the peripheral walls and the roof define an inner volume for receiving battery modules.

Such a container is intended to hold battery modules to offer a displaceable source of electrical power, able to be installed temporarily or permanently at a site requiring electrical power.

### BACKGROUND

Conventionally, it is known to build an electrical power storage system by arranging, in a standard parallelepiped container, battery modules and an electrical and thermal module management unit. This storage system is easy to displace, particularly by road, rail, sea or air.

The structure of the container receiving the battery modules generally includes a floor, peripheral walls projecting relative to the floor, and a flat roof which closes off the inner volume containing the battery modules. The peripheral walls are equipped with doors that allow access to the inner volume when required.

As standard, the container is equipped with corner pieces at the lower and upper corners. The lower corner pieces project downward relative to the floor, and the upper corner pieces project upward relative to the roof. Thus, the container can be arranged under another container, with the lower corner pieces of the other container resting on the upper corner pieces of the container.

Such a container is not entirely satisfying when placed outdoors. Indeed, the lower edge of the door is flush with the upper surface of the floor receiving the modules.

If an operator opens the container door in the event of rain, water is deposited on the inside of the door in the open position. This water is likely to run off onto the floor when the door is moved to the closed position.

Similarly, during transport, rainwater may seep along the inner face of the door to the floor.

The presence of stagnant water in the container is likely to generate humidity and condensation in the inner volume. This increases the risk of electric arcing in the event of projection onto power cables.

To alleviate this problem, it is known, for example, from CN 111 422 515, to fit a sloping protruding seal to the floor in order to block the entry of water into the module.

Such a solution protects the container. However, it is not satisfying for handling the battery modules, since the sloping seal protrudes from the surface of the floor.

Thus, to displace the battery modules that are stacked on top of each other, it is necessary to lift them to get over the protruding part, which complicates handling, given the mass of the modules. An alternative solution is to raise the modules relative to the floor, but this reduces the number of modules present in the container, and therefore the electrical power available.

### SUMMARY

One aim of the invention is therefore to obtain a battery module container that is highly resistant to adverse weather conditions, while offering easy handling of the battery modules, and providing maximized electrical power.

To this end, the invention has as its object a container of the aforementioned type, in which at least along the lower edge of the door in the closed position, the lateral edge of the upper surface of the floor extends to a height above the height of the upper face of the longitudinal member, the floor support defining a step between the upper face of the longitudinal member and the upper surface of the floor, the step delimiting, facing the door in the closed position, a water-receiving volume located below the upper surface of the floor and above the upper face of the longitudinal member.

The container according to the invention may comprise one or more of the following features, taken in isolation or according to all technically possible combinations:
the floor support includes a longitudinal beam laterally delimiting the step;
the longitudinal beam is fixed to the upper face of the longitudinal member;
the lateral edge of the floor is fixed to the longitudinal beam;
the crossmembers fixed to the longitudinal members have an upper face located above the upper face of the longitudinal member, the floor being attached to the upper faces of the crossmembers;
the upper surface of the floor features at least one flat lateral region in the vicinity of the lateral edge, the upper face of the longitudinal member being flat and parallel to the flat lateral region;
the length between the upper surface of the floor and the upper face of the longitudinal member is between 20 mm and 60 mm;
the longitudinal members are each formed by an IPN or a profiled beam with a polygonal profile;
the lower edge of the door is equipped with a seal applied to the upper face of the longitudinal member in the closed position of the door;
the lower edge of the door extends below the upper surface of the floor in the closed position of the door;
the structure defines pillars mounted above the lower corner pieces, the longitudinal members extending the full length between the pillars and the step extending the full length of the longitudinal member between the pillars; and
the container is elongated according to a longitudinal axis, the longitudinal members extending along the longitudinal axis of the container;
the water-receiving volume is defined by an outer lateral face of the longitudinal beam, the upper face of the longitudinal member and an inner face of the door in the closed position;
the width of the water-receiving volume, taken between the outer lateral face of the longitudinal beam and the inner lateral face of the door in the closed position, is greater than the width of the longitudinal beam taken between its lateral faces;
the floor, in particular the lateral edge of the floor, completely covers the upper face of the longitudinal beam.

The invention also has as its object an electrical power storage system, including:
a container as defined above;
battery modules received in the inner volume; and
terminals, connected to the battery modules and intended for connection to a consumer of electrical power supplied by the battery modules and/or to a supplier of electrical power for recharging the battery modules.

The electrical power storage system may comprise the following feature:
the structure includes an internal partition separating the inner volume to delimit a control room receiving at least one battery module management system, at least one storage room receiving the battery modules, at least one movable door extending facing the storage room, the step extending at least along the entire length of the storage room.

The invention also relates to a method of intervention in a storage system as defined above, comprising the following steps:
moving the door from the closed position to the open position to carry out the intervention,
depositing water on the inner face of the door in the open position,
moving the door from the open position to the closed position,
water flowing along the inner face to the lower edge of the door, and
collecting water in the water-receiving volume delimited by the step.

### BRIEF DESCRIPTION OF THE DRAWINGS

The invention will be better understood on reading the following description, given by way of example only, and made with reference to the appended drawings, on which:

FIG. 1, FIG. 2, FIG. 3 and FIG. 4 each illustrate an electrical power storage system according to the invention.

### DETAILED DESCRIPTION

The storage system 10 is intended to be displaced to a site of use, for example by a road vehicle such as a truck, by a rail vehicle, or/and by a sea vehicle such as a transport vessel. It is intended to be electrically connected to an electrical energy utilization network at a site of use and alternately to an electrical energy supply network for recharging.

The storage system 10 includes a container 12 of battery modules 16, delimiting an inner volume 14, and a plurality of battery modules 16 received in the inner volume 14. Advantageously, the storage system 10 includes a Battery Management Module (BMM) 18 for electrical and thermal management of the battery modules 16, and a safety system 20.

In this example, with reference to FIG. 2, the container 12 contains, for example, between 10 and 150 battery modules 16. The battery modules 16 are arranged in columns and rows. They are connected in series and/or parallel to deliver electrical power of up to 4 MWh at voltages of up to 1500V to at least two electrical terminals 22 on the container 12.

Each battery module includes a plurality of electrochemical cells, for example received in prismatic or cylindrical cases or in flexible pouches. Each electrochemical cell includes anodes, cathodes and separators, between which electrochemical reactions take place.

The management system 18 is able to control the voltage and current delivered by each battery module when supplying electrical power, and the electrical power and current delivered to each battery module when recharging the battery modules 16.

The electrical terminals 22 are intended to connect to the user network (not shown) for the supply of electrical energy stored in the battery modules 16, and alternately to an electrical power supply network, for recharging the battery modules 16.

The safety system 20 includes, for example, sensors (not shown) for detecting temperature and/or pressure in the inner volume 14, a source of inert gas 24, and a control unit 25, able to deliver inert gas into the inner volume 14 from the source of inert gas 24, on detection of an increase in temperature and/or pressure above a given threshold in the inner volume 14.

The container 12 comprises a self-supporting structure 30, intended to define the inner volume 14, and to allow the battery modules 16, the management system 18 and the safety system 20 to be transported together to a site of use.

The structure 30 includes a floor 32 mounted on a floor support 34. It includes peripheral walls 36 projecting from the periphery of the floor 32, the peripheral walls 36 being supported by vertical pillars 38 at the corners of the walls 36. In addition, it includes a roof 40 carried by a supporting framework 42.

The structure 30 of the container 12 is here polyhedral in shape. In particular, the structure 30 presents the shape of a rectangular parallelepiped, extending longitudinally along a longitudinal axis A-A′ which is horizontal when the container 12 is placed on a horizontal support.

The dimensions of the structure 30 are ruled by transport standards.

For example, the container 12 has a length greater than 2 m, in particular between 2.5 m and 15 m, a width greater than 1 m, in particular between 2 m and 4 m, and a height greater than 1 m, in particular between 2 m and 4 m.

In particular, the container 12 is a 20-foot “High Cube” container 6.058 m in length, 2.438 m in width and 2.896 m in height. However, the present invention applies to any type of container with ISO corners (for example, 40 ft (12 m), 10 ft (3 m), etc.).

The floor 32 is here flat. With reference to FIG. 3, it defines upward, an upper flat support surface 43, which supports the battery modules 16, the management system 18 as well as the safety system 20 when present.

The support surface 43 delimits downward, the inner volume 14. It has lateral edges 45, which extend facing the peripheral walls 36. It is supported by the floor support 34.

The floor support 34 is, for example, able to be gripped by the gripping members of a crane, in order to lift the container 12 and displace it.

The floor support 34 comprises at least two edge longitudinal members 60 extending along the longitudinal axis of the container 12 and crossmembers 64 transversely connecting the longitudinal members 60 to each other.

In this example, the floor support 34 also includes a longitudinal beam 65 fixed to the longitudinal member 60, on which the floor 32 is supported.

The floor support 34 is also equipped with lower corner pieces 44 extending at each corner defined between two adjacent peripheral walls 36.

The lower corner pieces 44 are ISO corners. They have a lower surface 48 intended to rest on the ground or on another support, the floor 32 then being located above the ground or support. The lower corner pieces 44 have lateral surfaces 46 to which the respective edge longitudinal members 60 are fixed.

In this example, as visible in FIG. 3, the edge longitudinal members 60 are each formed from a beam having in this case a polygonal or pseudo-polygonal cross-sectional profile.

Each edge longitudinal member 60 extends longitudinally along a respective longitudinal edge of the structure 30 over the entire length between the pillars 38. Each edge longitudinal member 60 has a flat upper face 62.

The crossmembers 64 are attached to the longitudinal members 60. They are perpendicular to the longitudinal members 60.

The crossmembers 64 have upper faces 66 which support the floor 32. Each upper face 66 of a crossmember 64 is here located adjacent to the upper face of an edge longitudinal member 62, at a height greater than the height of the upper face of the edge longitudinal member 62.

The longitudinal beam 65 is attached to the upper face 62 of the longitudinal member, along its inner edge, advantageously along the entire length of the longitudinal member 60 between the pillars 38.

Here, it is made of a polygonal section. Advantageously, its height is substantially equal to its width.

The longitudinal beam 65 has an outer lateral face 80 perpendicular to the upper face of the longitudinal member 62.

The upper face 82 of the beam 65 is flush with the upper face 66 of the crossmember 64.

The floor 32 is thus fixed to the upper face 66 of the crossmember 64, with its lateral edge 45 attached to the beam 65.

The upper surface 43 of the floor 32 here is flat. It extends at a height greater than that of the upper face of the longitudinal member 62.

Thus, the upper surface 43 of the floor 32, the lateral face 80 of the beam 65 and the upper face of the longitudinal member 62 define a protective step 84 between the longitudinal member 60 and the floor 32.

The step 84 here extends along the entire length of the longitudinal member 60 between the pillars 38. It has, for example, a height between 20 mm and 60 mm.

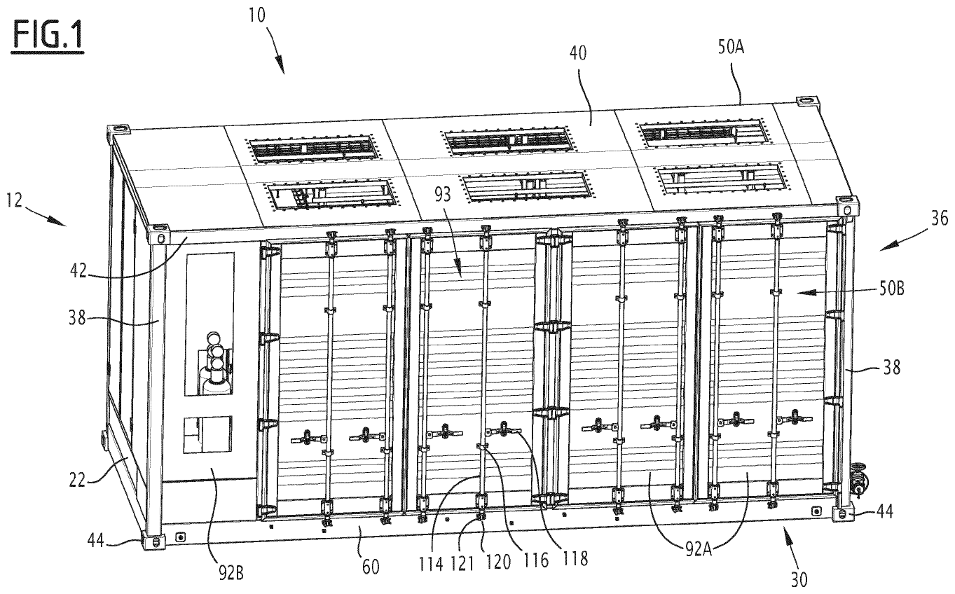

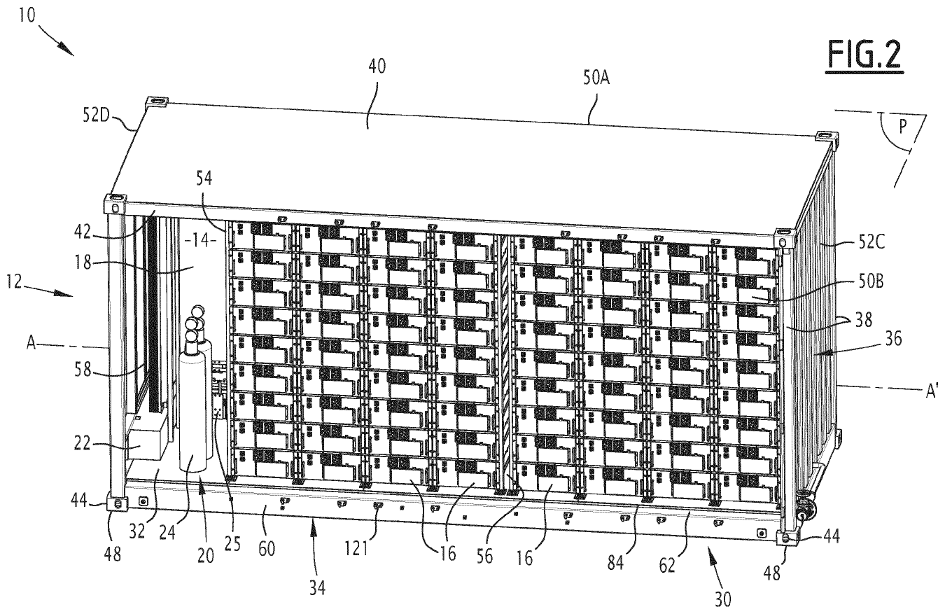

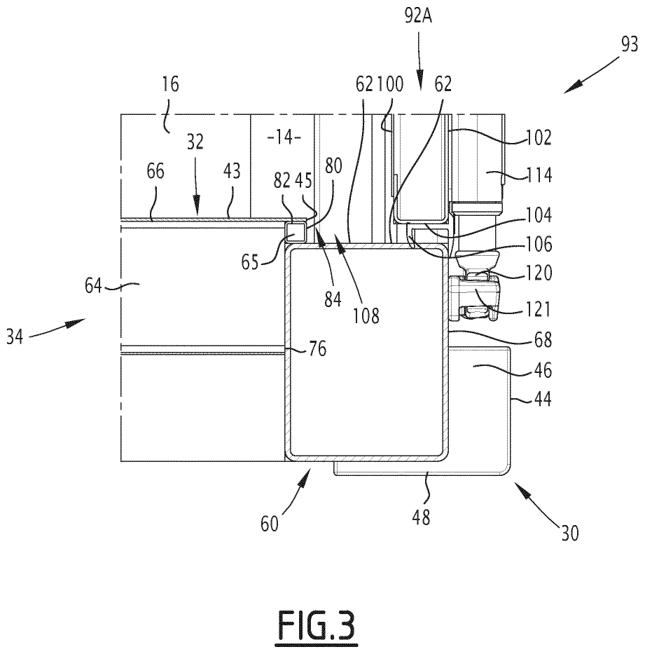

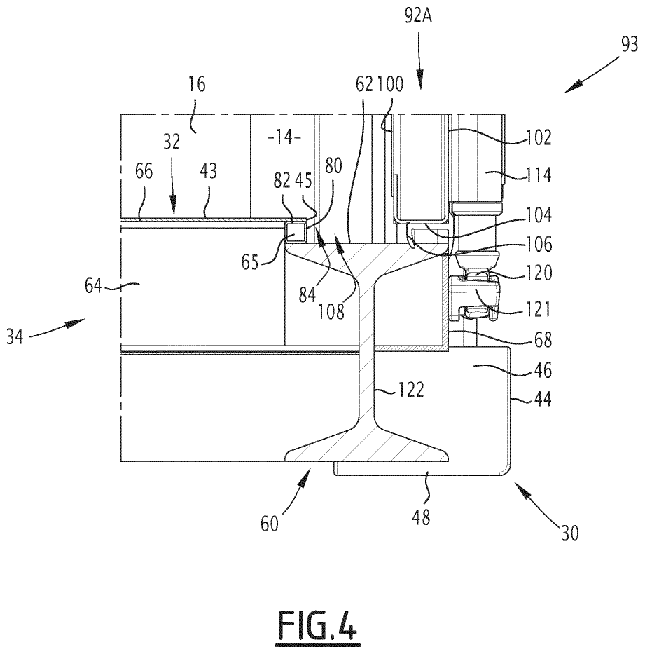

With reference to FIGS. 1 and 2, the peripheral walls 36 include two vertical longitudinal walls 50A, 50B, the longitudinal walls 50A, 50B being arranged vertically, parallel to the axis A-A′, on either side of the axis A-A′.

The peripheral walls 36 further include two vertical transverse walls 52C, 52D extending perpendicularly to the axis A-A′ and connecting the longitudinal walls 50 to each other at the longitudinal ends of the structure 30.

The longitudinal walls 50 and the transverse walls 52 delimit in pairs corners of the structure 30. They delimit the inner volume 14 toward the outside.

As visible in FIG. 1, the longitudinal walls 50 and optionally the transverse walls 52 are equipped with movable doors 92A, 92B providing an access passage to the inner volume 14 from outside the container 12, and a locking mechanism 93 for the movable doors 92A, 92B.

Advantageously, with reference to FIG. 2, the structure 30 also includes a partition 54 internal to the inner volume 14, delimiting in the inner volume 14 a room 56 for storing the battery modules 16, and separately, a control room 58, receiving the management system 18 and the safety system 20.

At least one door 92A arranged in a peripheral wall 36 allows access to the storage room 56, without having to open the control room 58, and at least one other door 92B allows access to the control room 58, without having to open the storage room 56.

With reference to FIG. 3, each door 92A has an inner face 100 intended to close the inner volume 14, an outer face 102, intended to carry the locking mechanism 93, and a lower edge 104 extending between the inner face 100 and the outer face 102.

Advantageously, each door 92A has a deformable seal 106 on its lower edge 104, intended to be applied to the upper face 62 of the edge longitudinal member 60.

Each door 92A is hinged about at least one vertical axis so as to be movable between a closed position and an open position.

In the open position, the door 92A has been pivoted to clear an access passage to the inner volume 14.

In the closed position, the door 92A extends parallel to the axis A-A′. The inner face 100 of the door closes the passage to close the inner volume 14.

Due to the presence of the step 84, the longitudinal members 60 have an upper face 62 lower than the upper surface 43 of the floor 32. The door 92A is then extended downward so that its lower edge 104 extends close to the upper face 62 of the edge longitudinal member 60.

The lower edge 104 of the door is thus located at an intermediate height between the upper surface 43 of the floor 32 and the upper face 62 of the edge longitudinal member, below the upper surface 43 of the floor 32.

The seal 106, when present, closes the gap between the lower edge 104 and the upper face 62 of the longitudinal member 60.

In the closed position, a lower region of the door 92A therefore extends facing the step 84, in particular the outer lateral face 80 of the longitudinal beam 65. The step 84 and the lower region of the door 92A define between them a water-receiving volume 108 which is located below the upper surface 43 of the floor 32.

The water-receiving volume 108 is defined by the outer lateral face 80 of the beam 65, the upper face 62 of the longitudinal member 60 and the inner face 100 of the door 92A.

This volume 108 is able to receive water present on the inner face 100 of the door 92A, which would run downward, preventing this water from being deposited on the upper surface 43 of the floor 32. The risk of contamination of the floor 32 by water running down the inner surface 100 of the door is therefore greatly reduced.

The step 84 thus defines a physical boundary forcing water, which runs off the door 92A, to be confined in the reception volume 108.

The height of the upper face 62 of the longitudinal member being lowered to form the step 84, the floor 32 keeps its upper surface 43 at the same height, which allows to maintain the inner volume 14 constant, and available for placing the battery modules 16.

Furthermore, the step 84 extending below the upper surface 43 of the floor 32, does not impede the handling of the battery modules 16, particularly when they need to be extracted from the inner volume 14. Even if a battery module 16 is placed on or just above the upper surface 43 of the floor 32, it can be removed without having to be lifted.

In addition, the step 84 forms an inner stop blocking the displacement of the door 92A toward the inner volume 14. The cooperation between the outer lateral face 80 of the longitudinal beam 65 and the lower region of the door prevents the door 92A from pivoting toward the inner volume 14 beyond the closed position. This prevents the door 92A from slamming onto the battery modules 16.

With reference to FIGS. 1 and 3, the locking mechanism 93 of the door 92A comprises in this example at least one espagnolette 114 rotatably mounted on the outer face 102 of the door, the fasteners 116 holding the espagnolette 114 to the door 92A, and an actuating handle 118 able to be gripped by a user.

Conventionally, the espagnolette 114 is equipped, at its lower end, with a blocking cam 120 for the door 92A. When the espagnolette 114 is rotated under the action of the handle 118, the cam 120 is able to rotate between a configuration engaged on a locking stop 121 carried by the structure 30, of the floor 32, in which the door 92A is locked in the closed position, and a configuration disengaged from the locking stop 121, in which the door 92A is free to pass into its open position.

In this example, the locking stop 121 is attached on an outer lateral face of the beam of the longitudinal member 60, ensuring robustness and precision in locking the door.

In operation, the container 12 is connected to a user network in order to deliver electrical power to this network from the battery modules 16 present in the container 12, or to a source of electrical power in order to recharge the battery modules 16 present in the container 12.

The doors 92A and 92B are generally held in a closed position, the espagnolette 114 of each door 92A being in a locked configuration.

To gain access to the inner volume 14 of the container 12, an operator unlocks the locking mechanism 93, advantageously by pivoting the espagnolette about its axis by manipulating the handle 118.

The operator then moves the door 92A to the open position to clear an access passage to the inner volume 14. The user can then enter and leave the inner volume 14 of the container 12.

In case of bad weather, each door 92A in the open position can receive water on its inner face 100.

When the operator moves the door 92A to the closed position and reactivates the locking mechanism 93, any water present on the inner face 100 of the door runs downward and is collected in the water-receiving volume 108 created by the step 84, avoiding contamination of the floor 32.

In one variant of the container 12, visible in FIG. 4, the structure 30 supporting the floor 34 differs from that visible in FIG. 3 in that the longitudinal members 60 are IPN beams 122 having an I-shaped cross-section. An IPN beam 122, having a height chosen so that its upper face 62 is not flush with the upper surface 43 of the floor 32, is used to create the step 84.

In one variant (not shown), the system is devoid of a longitudinal beam 65 between the upper face 62 of the longitudinal member 60 and the upper surface 43 of the floor 32. The step 84 is then devoid of an outer lateral face, or a simple cover can be positioned in place of the longitudinal beam 65 to form an outer lateral face of the step.

1. A battery module container, including a structure, the structure comprising:
a floor support, comprising two lateral longitudinal stringer, lower corner pieces fixed to the ends of the longitudinal stringers and crossmembers connecting the longitudinal stringers together, each longitudinal stringer having an upper face,
a floor supported by the floor support, the floor having a battery module upper support surface extending to lateral edges, the lateral edges being arranged facing the longitudinal stringers,
peripheral walls, at least one peripheral wall defining at least one door movable between a closed position, in which a lower edge of the door extends facing the upper face of the longitudinal stringer and an open position,
a roof, arranged above the peripheral walls, the floor, the peripheral walls and the roof defining an inner volume configured to receive battery modules,
wherein, at least along the lower edge of the door in the closed position, the lateral edge of the floor upper support surface extends to a height above a height of the upper face of the longitudinal stringer, the floor support defining a step between the upper face of the longitudinal stringer and the upper support surface of the floor, the step delimiting, facing the door in the closed position, a water-receiving volume located below the upper support surface of the floor and above the upper face of the longitudinal stringer.

2. The container according to claim 1, wherein the floor support includes a longitudinal beam laterally delimiting the step.

3. The container according to claim 2, wherein the longitudinal beam is fixed to the upper face of the longitudinal stringer.

4. The container according to claim 2, wherein the lateral edge of the floor is fixed to the longitudinal.

5. The container according to claim 1, wherein the crossmembers fixed to the longitudinal stringers have an upper face located above the upper face of the longitudinal stringer, the floor being attached to the upper faces of the crossmembers.

6. The container according to claim 1, wherein the upper support surface of the floor has at least one flat lateral region in the vicinity of the lateral edge the upper face of the longitudinal stringer being flat and parallel to the flat lateral region.

7. The container according claim 1, wherein a height between the upper support surface of the floor and the upper face of the longitudinal stringer is between 20 mm and 60 mm.

8. The container according to claim 1, wherein the longitudinal stringers are each formed of an IPN or a profiled beam with a polygonal profile.

9. The container according to claim 1, wherein the lower edge of the door is equipped with a seal applied to the upper face of the longitudinal stringer in the closed position of the door.

10. The container according to claim 1, wherein the lower edge of the door extends below the upper support surface of the floor in the closed position of the door.

11. The container according claim 1, wherein the structure defines pillars mounted above the lower corner pieces, the longitudinal stringers extending a full length between the pillars and the step extending a full length of the longitudinal stringer between the pillars

12. The container according to claim 1, wherein the container is elongated according to a longitudinal axis, the longitudinal stringers extending along the longitudinal axis of the container.

13. An electrical power storage system, including:
a container according to claim 1;
battery modules received in the inner volume;
terminals, connected to the battery modules and configured to connect to a consumer of electrical power supplied by the battery modules and/or to a supplier of electrical power to recharge the battery modules.

14. The system according to claim 13, wherein the structure includes an internal partition separating the inner volume to delimit a control room receiving at least one battery module manager, at least one storage room receiving the battery modules, at least one movable door extending facing the storage room, the step extending at least along an entire length of the storage room.
